(19) United States
(12) Patent Application Publication
(10) Pub. No.: US 2026/0273966 A1
(43) Pub. Date: Sep. 17, 2026

(54) PRINTING APPARATUS, CONTROL METHOD, AND A NON-TRANSITORY COMPUTER-READABLE STORAGE MEDIUM

(71) Applicant: CANON KABUSHIKI KAISHA, Tokyo (JP)

(72) Inventor: TOMOKI KOBAYASHI, Kanagawa (JP)

(21) Appl. No.: 19/568,101

(22) Filed: Mar. 16, 2026

(30) Foreign Application Priority Data
Mar. 17, 2025 (JP) 2025-042623

(51) Int. Cl. B41J 11/00; B41J 2/07; B41J 29/393

(52) U.S. Cl. CPC B41J 11/008; B41J 2/07; B41J 11/007; B41J 29/393

(57) ABSTRACT

A printing apparatus comprising a conveyance mechanism, a printhead, a printing control unit, a first trigger generation unit configured to generate a first trigger in synchronism with a sheet conveyance speed by the conveyance mechanism, and a second trigger generation unit configured to generate a second trigger at predetermined intervals, wherein the printing control unit performs first control of causing the printhead to print an image based on image data on a sheet while causing the conveyance mechanism to convey the sheet, the printhead being driven based on the first trigger, and second control of causing the printhead to print a discharge inspection pattern on a sheet while causing the conveyance mechanism to convey the sheet, the printhead being driven based on the second trigger.

### BACKGROUND

### Field of the Technology

The present disclosure relates to a printing apparatus, a control method, and a non-transitory computer-readable storage medium.

### Description of the Related Art

Some printing apparatuses such as an inkjet printer print a predetermined inspection pattern during execution of printing based on image data and execute inspection (discharge inspection) of whether a nozzle appropriately discharges ink. Japanese Patent Laid-Open No. 2020-142503 describes that a driving parameter for executing discharge inspection is switched from that for executing printing of an image in order to improve accuracy of discharge inspection.

In general, when executing printing of an image, an ink discharge timing is synchronized with a sheet conveyance speed. On the other hand, since a predetermined time is required for discharge inspection, when executing discharge inspection, it is difficult to synchronize an ink discharge timing with a sheet conveyance speed. Especially when attempting to speed up printing by increasing the sheet conveyance speed, it may become difficult to appropriately implement discharge inspection, resulting in deterioration in printing quality.

### SUMMARY

The present disclosure provides a technique advantageous in speeding up printing and improving printing quality.

One of the aspects of the present disclosure provides a printing apparatus including a conveyance mechanism configured to convey a sheet and a printhead configured to execute printing by discharging ink onto the sheet, comprising: a printing control unit configured to control driving of the printhead and the conveyance mechanism; a first trigger generation unit configured to generate a first trigger in synchronism with a sheet conveyance speed by the conveyance mechanism; and a second trigger generation unit configured to generate a second trigger at predetermined intervals, wherein the printing control unit performs first control of causing the printhead to print an image based on image data on a sheet while causing the conveyance mechanism to convey the sheet, and second control of causing the printhead to print a discharge inspection pattern on a sheet while causing the conveyance mechanism to convey the sheet, in the first control, the printhead is driven based on the first trigger, and in the second control, the printhead is driven based on the second trigger.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram showing an example of the configuration of a printing apparatus according to an embodiment;

FIG. 2 is a block diagram showing the detailed configuration of a nozzle data transfer unit and a printhead;

FIG. 3A is a schematic side view of a part of the printing apparatus;

FIG. 3B is a schematic plan view of the part of the printing apparatus;

FIG. 4A is a timing chart for explaining discharge inspection (determination of normal discharge or non-discharge);

FIG. 4B is a timing chart for explaining discharge inspection (determination of normal discharge or non-discharge);

FIG. 4C is a timing chart for explaining discharge inspection (determination of normal discharge or non-discharge);

FIG. 5 is a schematic view showing an example of print contents on a sheet;

FIG. 6 is a timing chart showing a mode of switching a discharge timing;

FIG. 7A is a schematic view showing the relative position of the printhead at a corresponding time;

FIG. 7B is a schematic view showing the relative position of the printhead at a corresponding time;

FIG. 7C is a schematic view showing the relative position of the printhead at a corresponding time;

FIG. 7D is a schematic view showing the relative position of the printhead at a corresponding time;

FIG. 7E is a schematic view showing the relative position of the printhead at a corresponding time;

FIG. 7F is a schematic view showing the relative position of the printhead at a corresponding time;

FIG. 7G is a schematic view showing the relative position of the printhead at a corresponding time;

FIG. 7H is a schematic view showing the relative position of the printhead at a corresponding time;

FIG. 8 is a flowchart illustrating a method of determining a region size;

FIG. 9A is a timing chart showing the waveform of the discharge timing;

FIG. 9B is a timing chart showing the waveform of the discharge timing;

FIG. 10 is a block diagram showing another example of the configuration of a printing apparatus according to an embodiment;

FIG. 11A is a schematic side view of another example of a part of the printing apparatus;

FIG. 11B is a schematic plan view of the other example of the part of the printing apparatus; and

FIG. 12 is a schematic view showing another example of print contents on a sheet.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

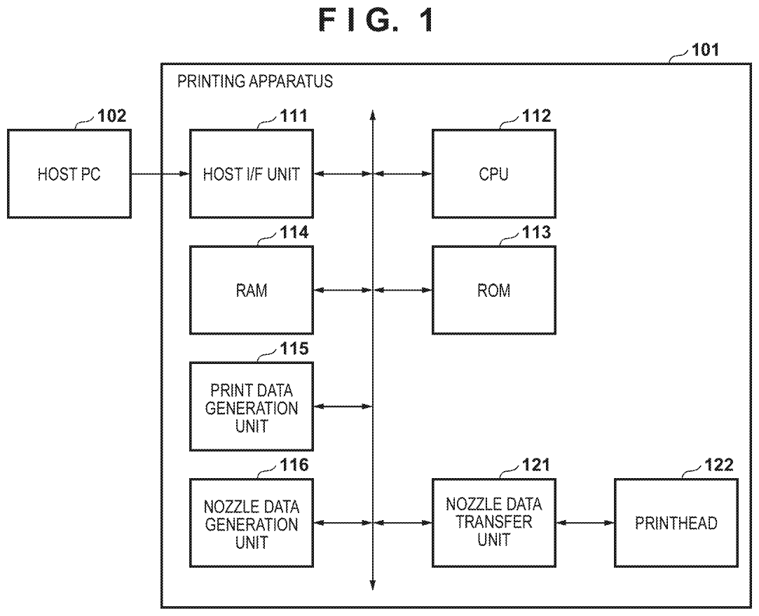

FIG. 1 is a block diagram showing an example of the configuration of a printing apparatus 101 according to the first embodiment. The printing apparatus 101 includes a host interface (I/F) 111, a Central Processing Unit (CPU) 112, a Read Only Memory (ROM) 113, and a Random Access Memory (RAM) 114. Furthermore, the printing apparatus 101 includes a print data generation unit 115, a nozzle data generation unit 116, a nozzle data transfer unit 121, and a printhead 122.

Each element (or module) provided in the printing apparatus 101 is driven or controlled when the CPU 112 deploys a program stored in the ROM 113 into the RAM 114 and executes it. For example, if a print job is input from a host Personal Computer (PC) 102, image data included in the print job is stored in the RAM 114 via the host I/F 111. The print data generation unit 115 and the nozzle data generation unit 116 generate, based on the image data, nozzle data for implementing printing by the printhead 122. The nozzle data is transferred to the printhead 122 by the nozzle data transfer unit 121.

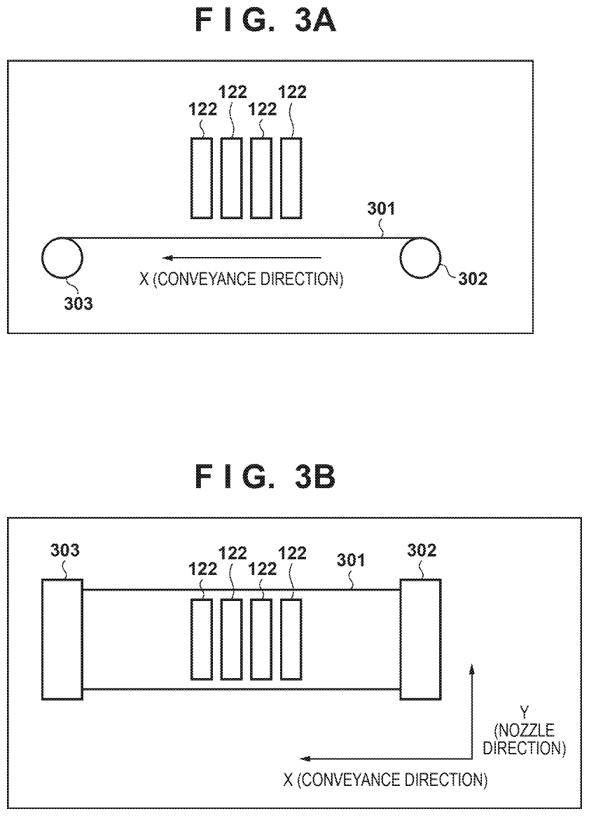

FIGS. 3A and 3B are respectively a schematic side view and a schematic plan view of a part of the printing apparatus 101. The printing apparatus 101 further includes a conveyance path 301, a feeding unit 302, and a discharge unit 303. The conveyance path 301, the feeding unit 302, and the discharge unit 303 are provided to be able to convey a sheet (which is a roll sheet in this embodiment but may be another print medium) as a printing target by the printhead 122.

This embodiment assumes that the printhead 122 is a line head in which a plurality of nozzles are arrayed in a direction (sheet width direction) substantially orthogonal to a sheet conveyance direction, and executes printing by the inkjet method of discharging ink from each nozzle. Ink is discharged by a thermal method using energy generated by an electrothermal transducer in this embodiment, but may be discharged by a piezoelectric method using energy generated by a piezoelectric element in another embodiment. With this configuration, a sheet supplied from the feeding unit 302 is conveyed along the conveyance path 301, and discharged by the discharge unit 303 after undergoing printing by the printhead 122.

The above-described conveyance path 301, feeding unit 302, and discharge unit 303 may be expressed as a conveyance mechanism by including a member forming the conveyance path 301 and a power source for driving the feeding unit 302 and/or the discharge unit 303.

This embodiment assumes that four printheads 122 are juxtaposed in the sheet conveyance direction, and can discharge, for example, inks of yellow (Y), magenta (M), cyan (C), and black (Bk), respectively.

Printing here indicates forming (or printing) an image by discharging ink onto a sheet, and the concept of an image includes a character, a number, a symbol, a graphic, and a photograph regardless of whether the image is visible. The ink is typically a liquid containing dye or pigment but may be a colorless and transparent reaction liquid, and they may be expressed as a liquid. From this viewpoint, the printing apparatus 101 may be expressed as a liquid discharge apparatus. Similarly, the printhead 122 may be expressed as a liquid discharge head.

Note that the printing apparatus 101 may be a copying machine having the above-described print function as a main function and further having, as sub-functions, additional functions such as a copy function, a scanner function, and a facsimile function.

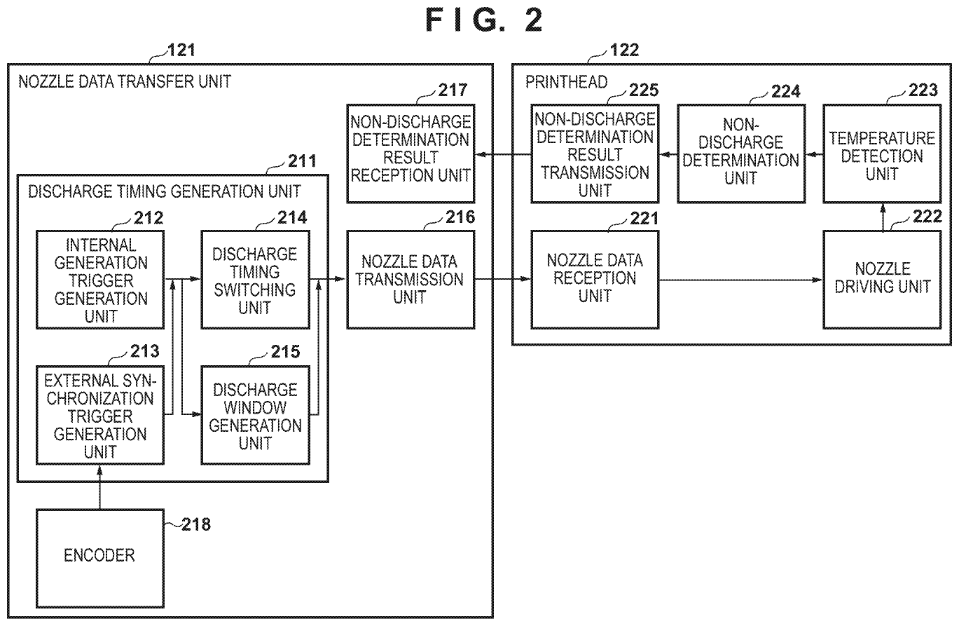

FIG. 2 is a block diagram showing the detailed configuration of the nozzle data transfer unit 121 and the printhead 122. The nozzle data transfer unit 121 is configured to execute transfer of nozzle data to the printhead 122, and includes a discharge timing generation unit 211, a nozzle data transmission unit 216, a non-discharge determination result reception unit 217, and an encoder 218. The encoder 218 is installed in the conveyance path 301, and can detect the sheet conveyance speed.

The discharge timing generation unit 211 includes an internal generation trigger generation unit 212, an external synchronization trigger generation unit 213, a discharge timing switching unit 214, and a discharge window generation unit 215.

The internal generation trigger generation unit 212 generates an internal generation trigger as a timing signal (to be described later) at predetermined fixed intervals.

The external synchronization trigger generation unit 213 generates, as a timing signal (to be described later), an external synchronization trigger synchronized with the sheet conveyance speed. The sheet conveyance speed can be specified based on a signal of the encoder 218, as described above.

That is, while the internal generation trigger is generated at the predetermined intervals regardless of the sheet conveyance speed, the external synchronization trigger is generated in accordance with the sheet conveyance speed.

The discharge timing switching unit 214 can select the timing signal as a signal for determining an ink discharge timing at the time of printing by switching to the above-described internal generation trigger or external synchronization trigger.

The discharge window generation unit 215 generates a discharge window indicating an ink discharge period (nozzle data output period), and transfers it to the nozzle data transmission unit 216. In this embodiment, a period during which ink discharge can be executed is represented by a discharge window at high level (H level), and a period during which ink discharge is suppressed is represented by a discharge window at low level (L level).

With this configuration, during a discharge window at H level, the nozzle data transmission unit 216 transfers nozzle data at the discharge timing (that is, the timing of the above-described internal generation trigger or external synchronization trigger) determined by the discharge timing generation unit 211.

Although details will be described later, the non-discharge determination result reception unit 217 can receive a non-discharge determination result (to be described later) from the printhead 122.

The printhead 122 includes a nozzle data reception unit 221, a nozzle driving unit 222, a temperature detection unit 223, a non-discharge determination unit 224, and a non-discharge determination result transmission unit 225. The nozzle data reception unit 221 receives nozzle data from the nozzle data transfer unit 121. Each nozzle is driven by the nozzle driving unit 222 based on the received nozzle data.

The temperature detection unit 223 can detect the temperature of ink in each nozzle, and can detect the temperature change of ink in the nozzle caused by ink discharge from the driven nozzle. The non-discharge determination unit 224 can determine, based on the detected temperature change, whether ink discharge is appropriately performed. This can specify, as a non-discharge nozzle, a nozzle from which ink discharge is not performed appropriately.

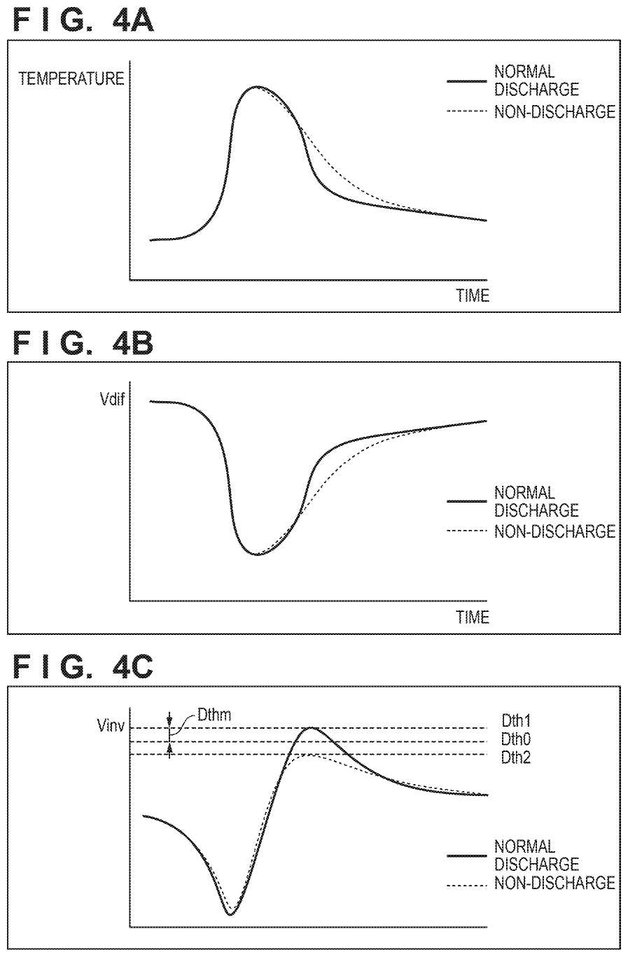

FIG. 4A shows the temperature change when the nozzle is driven. In a configuration using the thermal method, when ink is appropriately discharged by heating (normal discharge), the ink temperature decreases relatively quickly. To the contrary, when ink is not discharged appropriately (non-discharge), the ink temperature decreases relatively gradually.

FIG. 4B shows an electrical signal (voltage) corresponding to the temperature detected by the temperature detection unit 223. The detection result of the temperature detection unit 223 is transferred to the non-discharge determination unit 224, and the non-discharge determination unit 224 calculates the time differential of the detection result (the change amount of the detected temperature).

FIG. 4C shows the calculation result (the result of the time differential) of the non-discharge determination unit 224. If the time differential of the temperature change is large, normal discharge is determined; otherwise, non-discharge is determined. In this embodiment, a threshold Dth0 is preset. If the result of the time differential is larger than the threshold Dth0, normal discharge is determined, and if the result of the time differential is smaller than the threshold Dth0, non-discharge is determined. The threshold Dth0 is set to a value between a peak value Dth1 in the waveform of normal discharge and a peak value Dth2 in the waveform of non-discharge.

The temperature change corresponds to discharge information. From this viewpoint, it can be said that the temperature detection unit 223 functions as a discharge information acquisition unit and the non-discharge determination unit 224 functions as a discharge information evaluation unit.

The determination result of the non-discharge determination unit 224 is output to the nozzle data transfer unit 121 by the non-discharge determination result transmission unit 225. Determination of normal discharge or non-discharge including the above-described series of operations can be expressed as discharge inspection. The time required for discharge inspection corresponding to at least a time from when the nozzle is driven until the nozzle discharges ink and the non-discharge determination unit 224 accordingly performs the above-described determination processing. Therefore, when printing is executed at a high speed, each nozzle discharges ink at relatively short intervals (a relatively high frequency). However, when discharge inspection is executed, it is necessary to ensure the above required time.

This discharge inspection can be executed before the start of a printing operation and during the printing operation. For example, the discharge inspection before the start of the printing operation is performed while the printhead 122 is capped with a predetermined cap. On the other hand, the discharge inspection during the printing operation is performed by printing a discharge inspection pattern (a pattern for discharge inspection) in a region between a given page (image page) and the next page on the sheet.

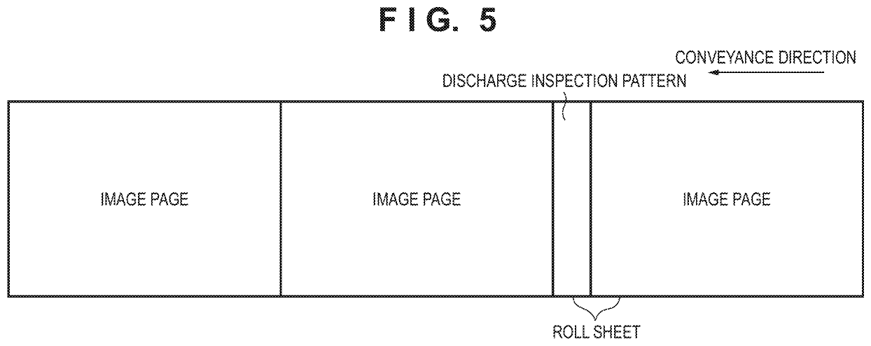

FIG. 5 is a schematic view showing print contents on the sheet according to this embodiment. In this example, as the print contents, an image page, a discharge inspection pattern, an image page, and an image page are sequentially arranged in the sheet conveyance direction. The discharge inspection pattern can be inserted between image pages for every predetermined number of pages (for example, every 50 pages, every 100 pages, or the like).

When printing an image page, the discharge timing switching unit 214 selects, as a discharge timing, the external synchronization trigger synchronized with the sheet conveyance speed. This can control the landing position of ink on the sheet. Note that the period of the external synchronization trigger when printing an image page is shorter than the time required for discharge inspection described above with reference to FIGS. 4A to 4C, but may be longer than the required time.

On the other hand, when printing the discharge inspection pattern, the discharge timing switching unit 214 selects the internal generation trigger as a discharge timing. Thus, since the external synchronization trigger is not used, it is possible to ensure the time required for discharge inspection regardless of the sheet conveyance speed.

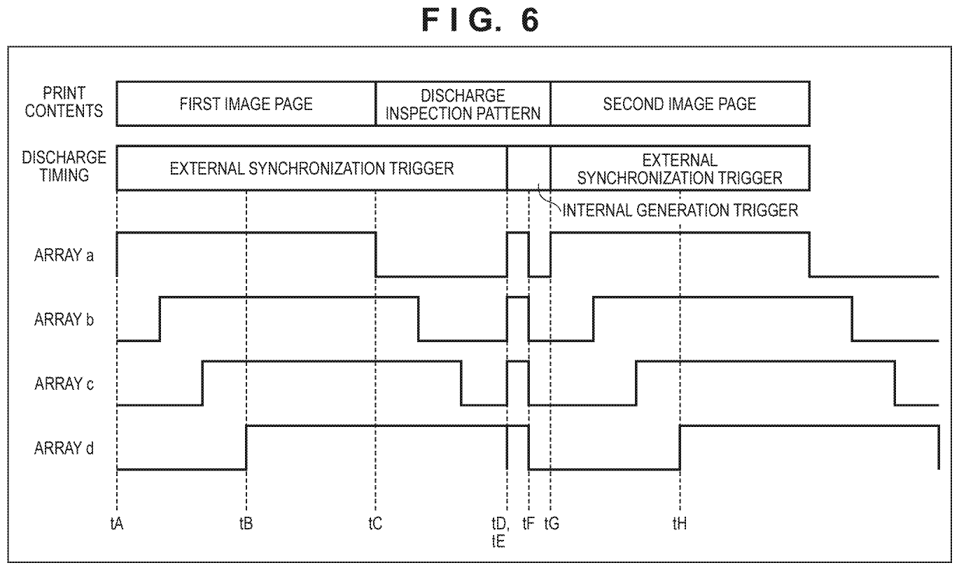

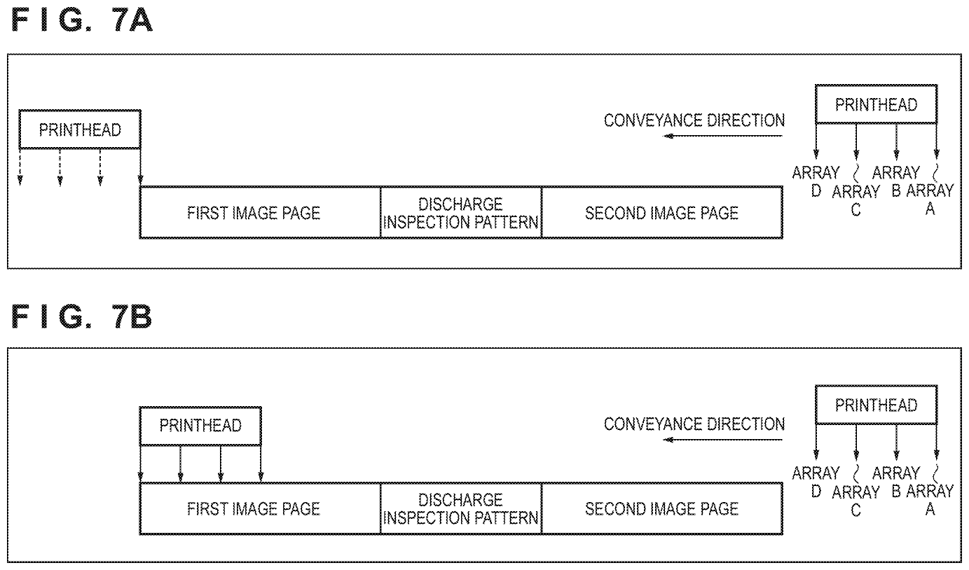

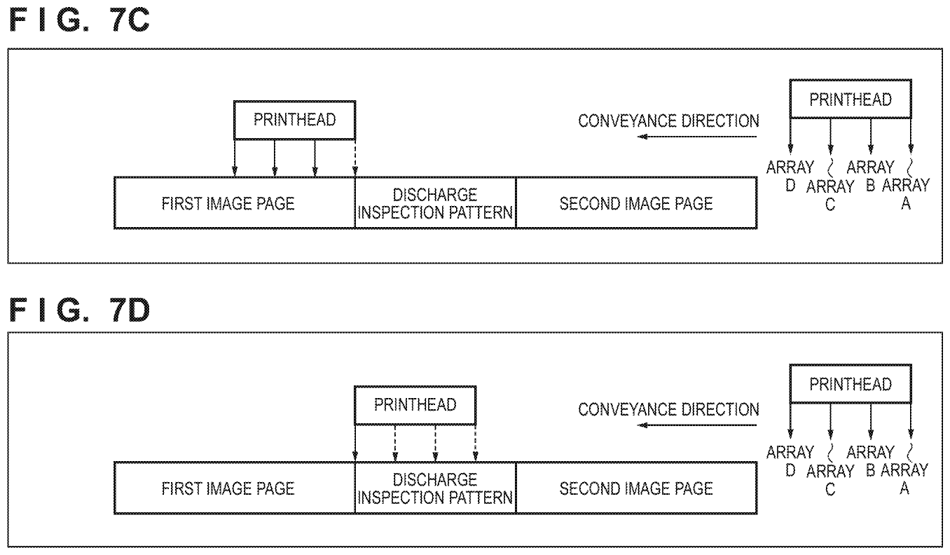

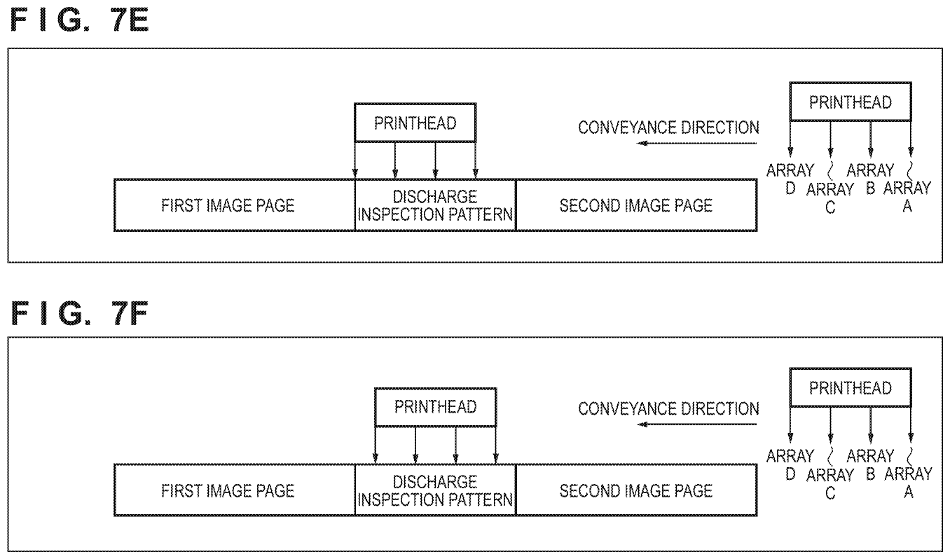

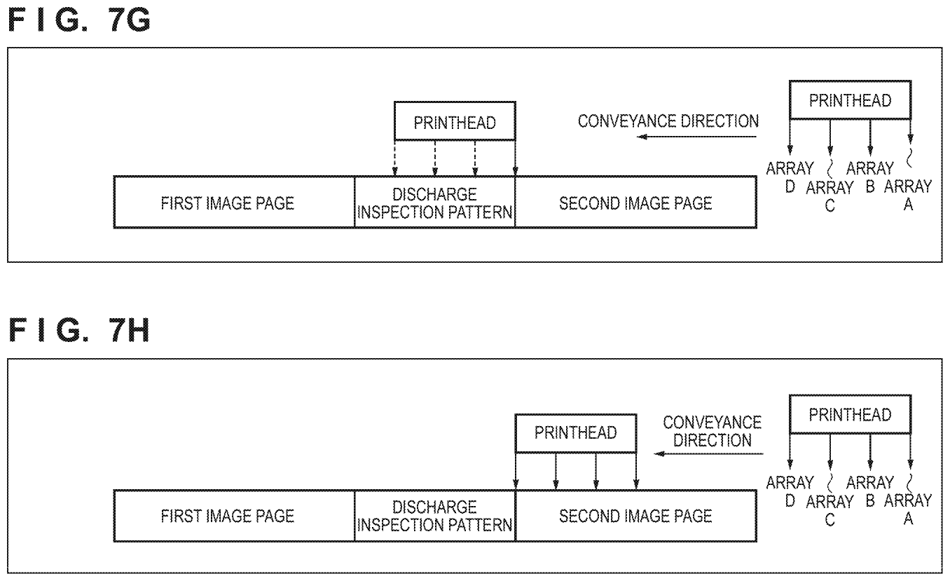

FIG. 6 is a timing chart showing a mode of switching the discharge timing by the discharge timing switching unit 214. FIGS. 7A to 7H respectively show the relative positions of the printhead 122 with respect to the sheet at times tA to tH.

For the sake of easy understanding, focusing on one of the four printheads 122 juxtaposed in the sheet conveyance direction (see FIG. 3), four nozzle arrays a, b, c, and d are provided from the upstream side in the conveyance direction in the printhead 122. That is, among the four nozzle arrays, printing is started from the nozzle array (in this example, the nozzle array a) on the upstream side, and is completed by the nozzle array (in this example, the nozzle array d) on the downstream side.

Referring to FIG. 6, for each of the nozzle arrays a to d, executing printing is expressed by a discharge window at H level.

As an example, consider a case where the first image page, the discharge inspection pattern, and the second image page are printed in this order.

At time tA, the nozzle array a starts printing for the first image page, and FIG. 7A shows the state.

After that, along with sheet conveyance, the nozzle arrays b and c sequentially start printing for the first image page.

At time tB, the nozzle array d starts printing for the first image page, and FIG. 7B shows the state.

Then, at time tC, the nozzle array a completes the printing for the first image page, and FIG. 7C shows the state.

After that, along with sheet conveyance, the nozzle arrays b and c sequentially complete the printing for the first image page.

At time tD, the nozzle array d completes the printing for the first image page, and FIG. 7D shows the state.

During the above period from time tA to time tD, since the printing for the first image page is performed, the discharge timing switching unit 214 selects the external synchronization trigger as the discharge timing.

Almost at the same time, the nozzle arrays a to d start printing for the discharge inspection pattern. Since the nozzle array d starts printing for the discharge inspection pattern almost at the same time as the completion of the printing for the first image page, it is continuously driven. This time is set as time tE, and FIG. 7E shows the state.

After that, as shown at time tF, the nozzle arrays a to d complete the printing for the discharge inspection pattern, and FIG. 7F shows the state.

During the above period from time tE to time tF, since the printing for the discharge inspection pattern is performed, the discharge timing switching unit 214 selects the internal generation trigger as the discharge timing. Note that for the nozzle array d, although a discharge window at H level is indicated from time tB to time tF, a discharge window from time tB to time tD corresponds to a period for printing the first image page, and a discharge window from time tE (tD) to time tF corresponds to a period for printing the discharge inspection pattern.

That is, while the plurality of nozzle arrays a to d sequentially start printing and sequentially complete the printing in printing of the first and second image pages, the plurality of nozzle arrays a to d simultaneously start printing and simultaneously complete the printing in printing of the discharge inspection pattern.

Sheet conveyance is further continued. At time tG after that, the nozzle array a starts printing for the second image page, and FIG. 7G shows the state.

After that, along with sheet conveyance, the nozzle arrays b and c sequentially start printing for the second image page.

At time tH, the nozzle array d starts printing for the second image page, and FIG. 7H shows the state.

From time tG, since the printing for the second image page is performed, the discharge timing switching unit 214 selects the external synchronization trigger as the discharge timing.

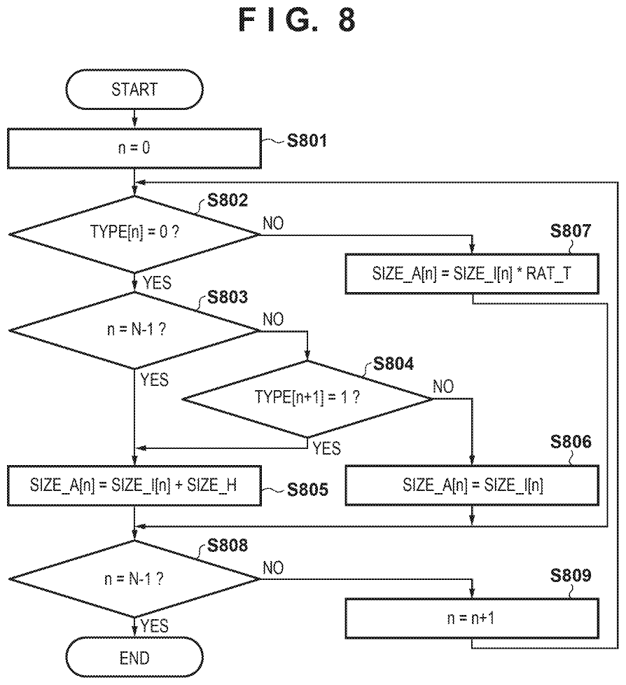

FIG. 8 is a flowchart illustrating a method of determining the region size of each of the image page and the discharge inspection pattern (the size/length in the sheet conveyance direction of a region assigned on the sheet). This flowchart is mainly performed by the CPU 112. An outline of the flowchart is to determine the region size based on whether the print region is the image page or the discharge inspection pattern and determine, in a case where the print region is the image page, the region size based on whether the next print region is the image page or the discharge inspection pattern. For each of the image page and the discharge inspection pattern, the nozzle data transfer unit 121 transfers nozzle data based on the region size determined by this flowchart.

Although details will be described later, to determine each of the region size determined for the image page and the region size determined for the discharge inspection pattern, the number of external synchronization triggers along with sheet conveyance during the printing is used. That is, the discharge inspection pattern is printed at the discharge timing based on the internal generation trigger, but the region size of the discharge inspection pattern depends on the number of external synchronization triggers. Thus, even if the sheet conveyance speed changes (the interval (period) of the external synchronization trigger changes) during printing of the discharge inspection pattern, it is possible to print the discharge inspection pattern in a predetermined region in accordance with the internal generation trigger.

The following parameters are used in processing of each step in this flowchart.

N: the number of print regions (regions of the image pages or discharge inspection patterns)
n: the ordinal number of the print region (n is an integer of 0 to (N−1))
TYPE[n]: the type of print contents (the image page for TYPE[n]=0 and the discharge inspection pattern for TYPE[n]=1)
SIZE_A[n]: the region size of the print region
SIZE_I[n]: the maximum print count of each nozzle array in the print region
SIZE_H: the distance from the nozzle array a to the nozzle array d
RAT_T: a coefficient (fixed value)

Note that the coefficient RAT_T is set by the ratio between the interval of the external synchronization trigger and the interval of the internal generation trigger. As described above, the external synchronization trigger is generated in synchronism with the sheet conveyance speed. When setting the coefficient RAT_T, the minimum value (the interval when the sheet conveyance speed is highest (in consideration of variations)) is employed as the interval of the external synchronization trigger.

In step S801 (to be referred to as “S801” hereinafter, the same applies to other steps to be described later), n=0 is set and the first print region is set.

In S802, it is determined whether the target print region is the image page or not (TYPE[n]=0 or not). If the target print region is the image page (TYPE[n]=0), the process advances to S803; otherwise (if TYPE[n]=1, that is, the target print region is the discharge inspection pattern), the process advances to S807.

In S803, it is determined whether the target print region is the last print region or not (n=(N−1) or not). If the target print region is the last print region (n=(N−1)), the process advances to S805; otherwise (if n<(N−1), that is, there exists the next print region), the process advances to S804.

In S804, it is determined whether the next print region is the discharge inspection pattern or not (TYPE[n+1]=1 or not). If the next print region is the discharge inspection pattern (TYPE[n+1]=1), the process advances to S805; otherwise (if TYPE[n+1]=0, that is, the next print region is the image page), the process advances to S806.

In S806 (that is, if the target print region is the image page and the next print region is also the image page), the region size of the target print region is determined by:

$$SIZE\_A [ n ] = SIZE\_I [ n ]$$

This indicates that the region size of the target print region corresponds to, for example, a sheet conveyance distance required by the nozzle array a (or the nozzle array b, c, or d) to discharge ink by the maximum print count.

In S805 (that is, if the target print region is the image page and the next print region is the discharge inspection pattern), the region size of the target print region is determined by:

$$SIZE\_A [ n ] = SIZE\_I [ n ] + SIZE\_H$$

This indicates that the region size of the target print region corresponds to a sheet conveyance distance required from the start of printing by the nozzle array a to the completion of printing by the nozzle array d.

In S807 (that is, if the target print region is the discharge inspection pattern), the region size of the target print region is determined by:

$$SIZE\_A [ n ] = SIZE\_I [ n ] * RAT\_T$$

As described above, the coefficient RAT_T is set by the ratio between the interval of the external synchronization trigger and the interval of the internal generation trigger, and the minimum value is employed as the interval of the external synchronization trigger. Thus, even if the sheet conveyance speed is highest, the discharge inspection pattern is printed in a predetermined region in the sheet conveyance direction.

In S808, it is determined whether the target print region is the last print region or not (n=(N−1) or not) (similar to S803). If the target print region is the last print region (n=(N−1)), this flowchart ends; otherwise (if n<(N−1), that is, there exists the next print region), the process advances to S809.

In S809, n is incremented to designate the next print region (n=n+1), and the process returns to S802.

As described above, the region size is determined for each of the image page and the discharge inspection pattern. When printing the discharge inspection pattern, even if the sheet conveyance speed changes (the interval of the external synchronization trigger changes) during the printing, the discharge inspection pattern is printed in a predetermined region in the sheet conveyance direction in accordance with the internal generation trigger.

The sheet on which the image pages and the discharge inspection patterns are printed is cut for each image page or each discharge inspection pattern by a predetermined cutter unit (not shown) on the downstream side, and discharged outside the printing apparatus 101 one by one. As the cutter unit, a known component is employed.

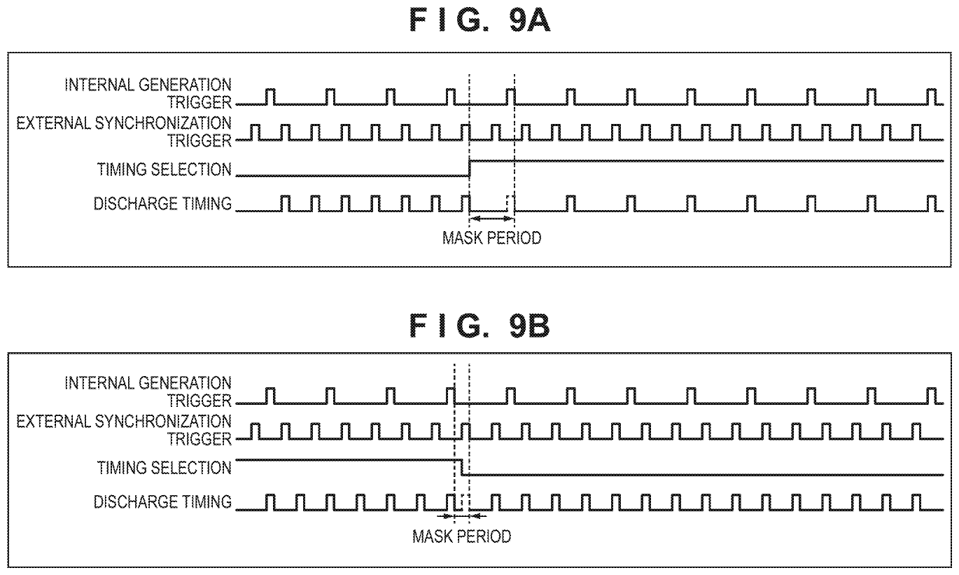

FIGS. 9A and 9B each show the waveform of the timing signal (discharge timing) switched by the discharge timing switching unit 214. FIG. 9A shows the waveform of the discharge timing when the external synchronization trigger is switched to the internal generation trigger. FIG. 9B shows the waveform of the discharge timing when the internal generation trigger is switched to the external synchronization trigger.

When switching the discharge timing, one pulse of the timing signal immediately after the switching is masked, thereby making it possible to prevent the interval of the discharge timing from becoming unnecessarily short.

According to this embodiment, when printing the image page, the external synchronization trigger (first trigger) synchronized with the sheet conveyance speed is selected as the discharge timing, thereby making it possible to control the landing position of ink on the sheet. On the other hand, when printing the discharge inspection pattern, the internal generation trigger (second trigger) generated at predetermined intervals regardless of the sheet conveyance speed is selected as the discharge timing, thereby making it possible to ensure the time required for discharge inspection regardless of the sheet conveyance speed. Therefore, even in a case where the sheet conveyance speed is relatively high (the interval of ink discharge when printing the image page is short), it is possible to ensure the time required for discharge inspection and accurately implement the discharge inspection. According to this embodiment, it is advantageous in speeding up printing and improving printing quality.

### Second Embodiment

The second embodiment is different from the above-described first embodiment in that an image reading unit 131 is arranged on the downstream side in a sheet conveyance direction with respect to a printhead 122 and inspection other than discharge inspection can further be executed.

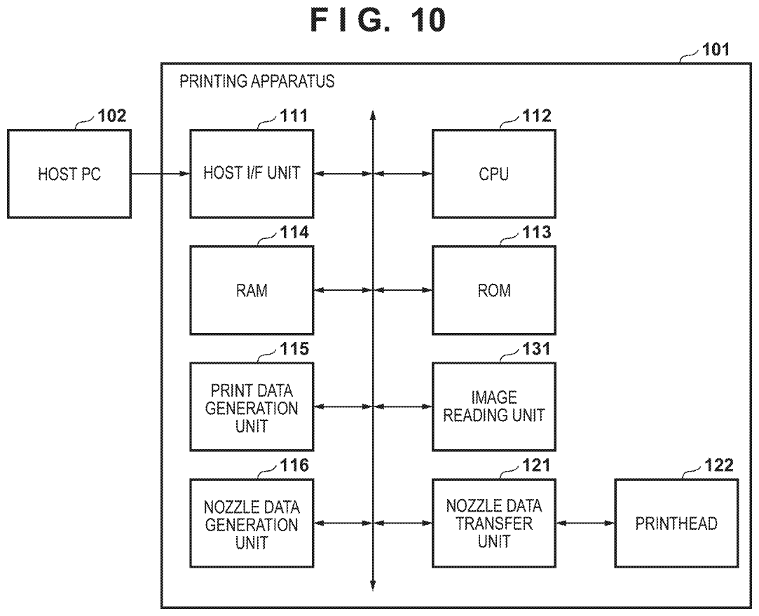

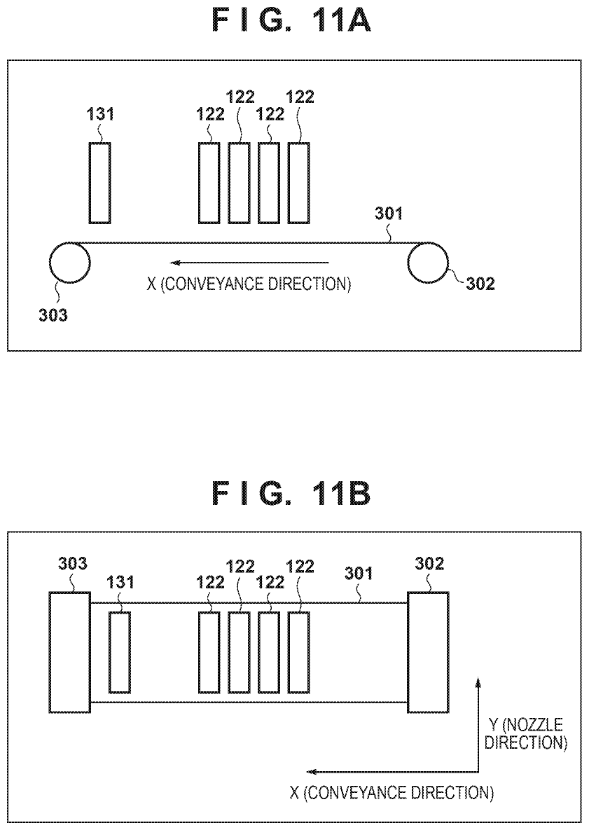

FIG. 10 is a block diagram showing an example of the configuration of a printing apparatus 101. FIGS. 11A and 11B are respectively a schematic side view and a schematic plan view of a part of the printing apparatus 101. The image reading unit 131 can read an image printed by the printhead 122, and evaluate the image based on the reading result.

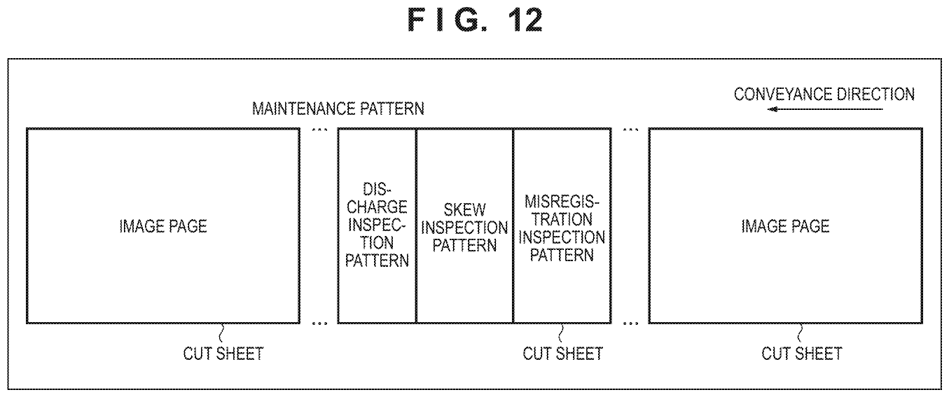

FIG. 12 is a schematic view showing print contents on a sheet according to this embodiment. This embodiment considers a case where a cut sheet cut to a predetermined length is used as a print medium and an image page for one page is printed on one cut sheet. This embodiment assumes that a maintenance page is inserted between image pages for every predetermined number of pages (for example, every 50 pages, every 100 pages, or the like), and printed on a cut sheet for one page.

In this embodiment, in addition to the above-described discharge inspection pattern, a skew inspection pattern and a misregistration inspection pattern are printed as a maintenance page on a cut sheet for one page. The skew inspection pattern is used to inspect deflection (skew) of the ink discharge direction caused by clogging of a nozzle or the like. The misregistration inspection pattern is used to inspect a shift (misregistration) of the landing position of ink caused by misalignment of the printhead 122. This embodiment assumes that the misregistration inspection pattern, the skew inspection pattern, and the discharge inspection pattern are printed in this order from the upstream side in the sheet conveyance direction.

The image reading unit 131 can read each pattern on the maintenance page, and detect a skew and a misregistration based on the skew inspection pattern and the misregistration inspection pattern, respectively. Therefore, for each of the skew inspection pattern and the misregistration inspection pattern, it is necessary to specify the printing position on the cut sheet, and thus an external synchronization trigger synchronized with a sheet conveyance speed is selected as a discharge timing, similar to the image page. Note that when printing the discharge inspection pattern, an internal generation trigger generated at predetermined intervals regardless of the sheet conveyance speed is selected as a discharge timing, similar to the first embodiment.

Each of the skew inspection pattern and the misregistration inspection pattern can be said to be a pattern used to inspect accuracy of the landing position of ink rather than discharge inspection (normal discharge/non-discharge of a nozzle). Therefore, in addition to the above-described reason why the external synchronization trigger is selected as the discharge timing, the skew inspection pattern and the misregistration inspection pattern may collectively be expressed as a misalignment inspection pattern, and may be distinguished from the discharge inspection pattern.

In the example shown in FIG. 12, the misregistration inspection pattern, the skew inspection pattern, and the discharge inspection pattern are printed in this order from the upstream side, but the order may be changed. However, when printing the skew inspection pattern and the misregistration inspection pattern among these three patterns, the external synchronization trigger is selected as the discharge timing, and thus the skew inspection pattern and the misregistration inspection pattern are preferably, consecutively printed.

In the example shown in FIG. 12, these three patterns are printed on the same cut sheet. However, as another example, some of the patterns may be printed on another cut sheet. Alternatively, as still another example, one of the skew inspection pattern and the misregistration inspection pattern may be omitted.

According to this embodiment, in addition to obtaining the same effect as in the first embodiment, it is possible to perform skew inspection and misregistration inspection, and it can be advantageous in further improving printing quality.

### Program

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

### Others

In the embodiments, each element is named using an expression based on its main function. However, each function described in the embodiments may be a sub-function, and is not strictly limited to the expression. The expression can be replaced with another similar expression.

Two or more elements selectably exemplified in the embodiments are not strictly limited to the exemplification, and may arbitrarily be combined. For example, each of the two or more elements exemplified may be additionally selected or alternatively selected. As an example, when arbitrarily combining two elements A and B, to indicate one of “only A”, “only B”, and “both A and B”, an expression “A and/or B” may be used, or an expression “at least one of A and B” may be used.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2025-042623, filed Mar. 17, 2025, which is hereby incorporated by reference herein in its entirety.

What is claimed is:

1. A printing apparatus including a conveyance mechanism configured to convey a sheet and a printhead configured to execute printing by discharging ink onto the sheet, comprising:
a printing control unit configured to control driving of the printhead and the conveyance mechanism;
a first trigger generation unit configured to generate a first trigger in synchronism with a sheet conveyance speed by the conveyance mechanism; and
a second trigger generation unit configured to generate a second trigger at predetermined intervals,
wherein the printing control unit performs first control of causing the printhead to print an image based on image data on a sheet while causing the conveyance mechanism to convey the sheet, and
second control of causing the printhead to print a discharge inspection pattern on a sheet while causing the conveyance mechanism to convey the sheet,
in the first control, the printhead is driven based on the first trigger, and
in the second control, the printhead is driven based on the second trigger.

2. The apparatus according to claim 1, further comprising a conveyance speed detection unit configured to detect the sheet conveyance speed by the conveyance mechanism,
wherein the first trigger generation unit generates the first trigger based on a detection result of the conveyance speed detection unit.

3. The apparatus according to claim 1, wherein the printhead includes
a nozzle configured to discharge ink,
a temperature detection unit configured to detect a temperature of the ink in the nozzle, and
a determination unit configured to determine, based on a detection result of the temperature detection unit, whether the nozzle appropriately discharges the ink.

4. The apparatus according to claim 1, wherein
the printhead includes a plurality of nozzle arrays juxtaposed in a sheet conveyance direction, each of which is arrayed in a sheet width direction,
in the first control, the printhead is driven so that the plurality of nozzle arrays sequentially start printing from an upstream side in the sheet conveyance direction and sequentially complete the printing from the upstream side, and
in the second control, the printhead is driven so that the plurality of nozzle arrays simultaneously start printing and simultaneously complete the printing.

5. The apparatus according to claim 1, further comprising a switching unit configured to switch between the first trigger and the second trigger,
wherein at a time of switching from one of the first trigger and the second trigger to the other, one pulse of the other trigger immediately after the switching is masked.

6. The apparatus according to claim 1, wherein in the second control, the printing control unit further causes the printhead to print another pattern different from the discharge inspection pattern based on the first trigger.

7. The apparatus according to claim 6, further comprising an image reading unit arranged on a downstream side in a sheet conveyance direction with respect to the printhead and configured to read the other pattern.

8. The apparatus according to claim 7, wherein the other pattern includes a pattern for inspecting deflection of an ink discharge direction and/or a pattern for inspecting misalignment of the printhead.

9. A control method for a printing apparatus including a conveyance mechanism configured to convey a sheet and a printhead configured to execute printing by discharging ink onto the sheet, comprising:
generating a first trigger in synchronism with a sheet conveyance speed by the conveyance mechanism;
generating a second trigger at predetermined intervals;
causing the printhead to print an image based on image data on a sheet while causing the conveyance mechanism to convey the sheet; and
causing the printhead to print a discharge inspection pattern on a sheet while causing the conveyance mechanism to convey the sheet,
wherein in the causing the printhead to print the image based on the image data, the printhead is driven based on the first trigger, and
in the causing the printhead to print the discharge inspection pattern, the printhead is driven based on the second trigger.

10. A non-transitory computer-readable storage medium storing a program, the program configured to cause a computer to perform each step of the control method according to claim 9.
